(19) United States
(12) Patent Application Publication
(10) Pub. No.: US 2008/0293028 A1
(43) Pub. Date: Nov. 27, 2008

(54) Breathing Manikin

(75) Inventors: Einar Mestad, Hundvag (NO); Hakon Hodne, Kleppe (NO); Oyvind Tjolsen, Stavanger (NO)

Correspondence Address: BROOKS KUSHMAN P.C., 1000 TOWN CENTER, TWENTY-SECOND FLOOR, SOUTHFIELD, MI, 48075, US

(73) Assignee: LAERDAL MEDICAL AS, Stavanger (NO)

(21) Appl. No.: 11/570,288

(22) PCT Filed: Jun. 3, 2005
(86) PCT No.: PCT/NO05/00186

§ 371 Date: Dec. 8, 2006

(30) Foreign Application Priority Data
Jun. 9, 2004 (NO) 2004 2402

(51) Int. Cl. G09B 23/30

(52) U.S. Cl. 434/267

(57) ABSTRACT

A medical training manikin (1) to simulate spontaneous breathing, comprising a torso containing at least one pneumatic actuator (3) for obtaining raise of the manikin's chest or stomach. The actuator (3) is connected to an accumulator (7) via a control valve (5), which is designed to let air from the accumulator (7) into the actuator (3). The accumulator (7) is designed to be temporarily connected to an external pneumatic source (8) for filling of the accumulator (7) with a pneumatic pressure adequate for repeated actuations by the actuator (3).

The present invention relates to a medical patient simulator device, in particular a device for simulating spontaneous breathing with a training doll, a so-called manikin, as defined in the preamble of the subsequent claim 1.

The invention concerns systems intended for patient simulators (especially dolls or so-called manikins) used for medical teaching and training. It is an object for the manikin to exhibit various signs of illness and both normal and abnormal bodily functions in order to allow the users to make a diagnosis and take corrective measures. In connection with practising treatments it is desirable to simulate so-called spontaneous breathing with a patient. Spontaneous breathing implies that the patient begins to breathe by its own.

Previous solutions for simulating spontaneous breathing are known. Common for these is that the mechanism that provides the breathing is very complicated. An example of such known device is shown in GB 1291198. Here the raise of the chest is provided by a number of small pneumatics cylinders that are supplied with air from a respective air bladder. The air bladder is squeezed together by a cam mechanism driven by a shaft which is connected to an electric motor. Even though the mechanism is able to provide complex breathing patterns, it occupies a great deal of space. Today's manikins have gradually been filled with a high degree of functionality and it is therefore little room available for new equipment in the manikin. It is therefore an object of the present invention to provide a device for simulating spontaneous breathing, which does not occupy much space. Moreover, it is an object to provide a device for simulating spontaneous breathing, which consists of inexpensive components.

This is achieved according to the present invention by a device characterized by the features which appears in the characterising part of the subsequent claim 1.

The invention will now be described in greater detail with reference to an embodiment example shown in the following drawings, in which:

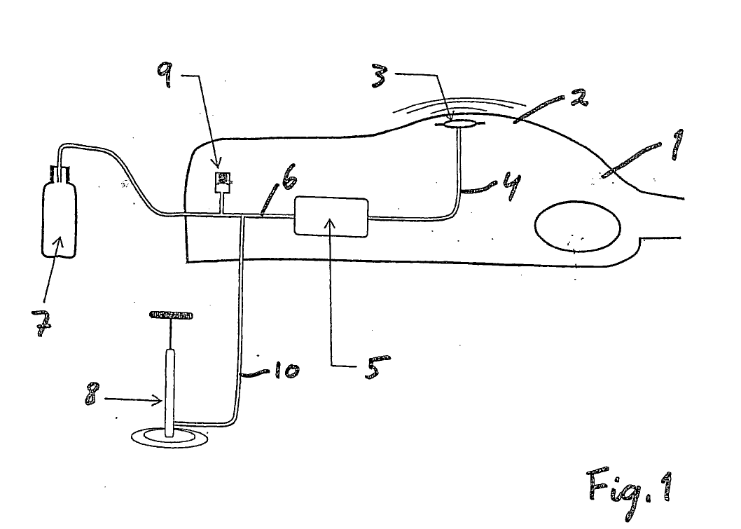

FIG. 1 shows the principles schematically with an embodiment of the invention,

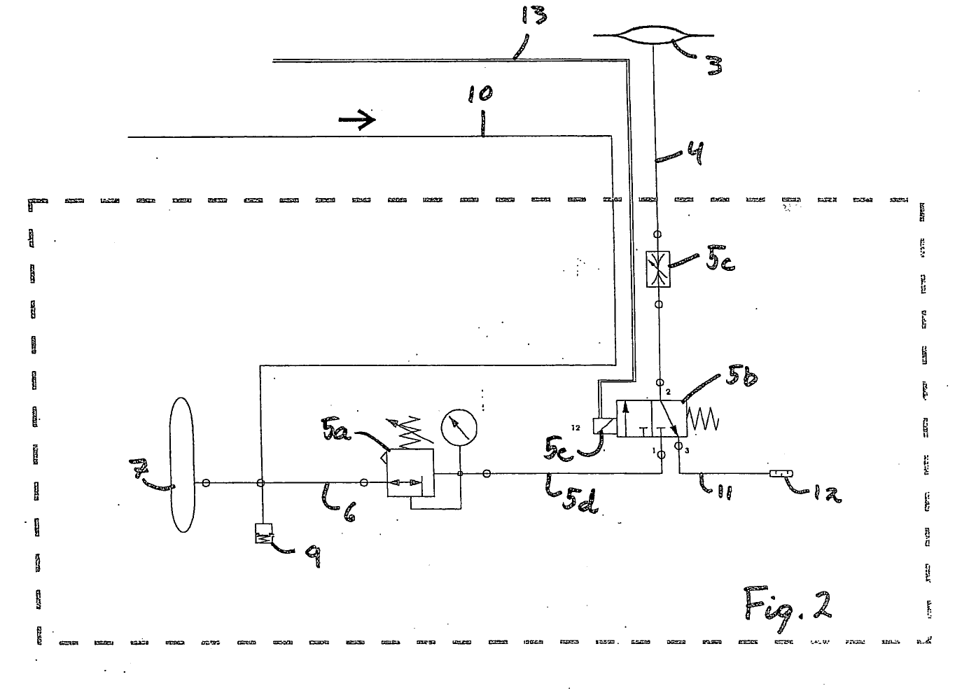

FIG. 2 shows a circuit diagram for the embodiment in FIG. 1,

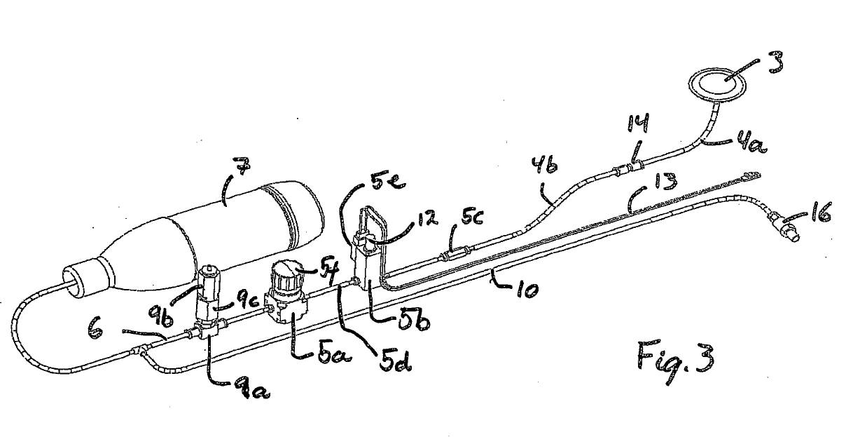

FIG. 3 shows components and flow lines between these, and

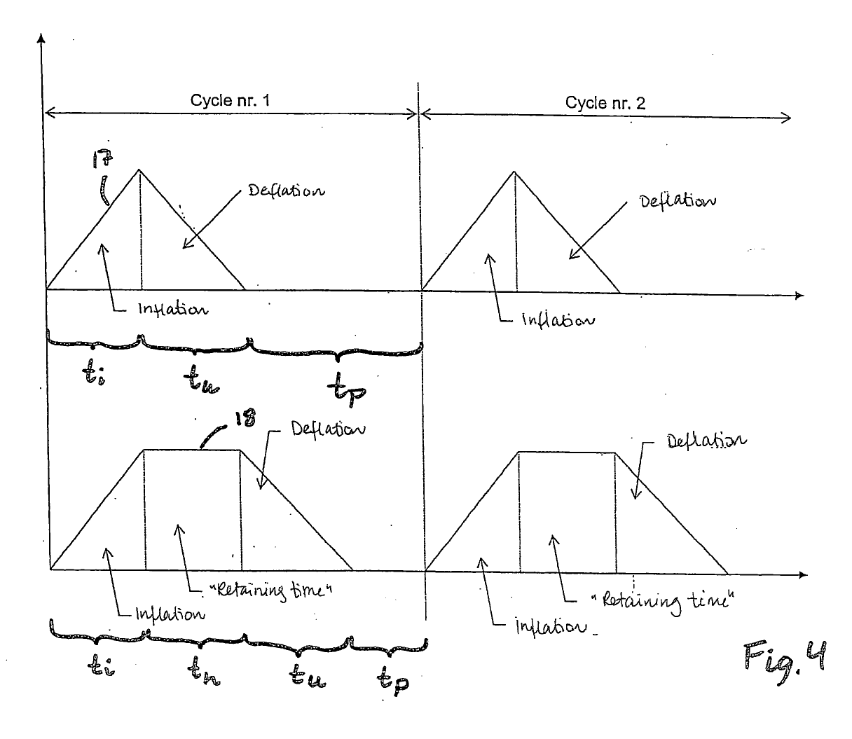

FIG. 4 shows examples of potential breathing patterns.

An embodiment of the invention is shown schematically in FIG. 1. The manikin is referred to with reference number 1. Under a breast plate (not shown) in the manikin's chest 2 an inflatable bladder 3 is placed. The bladder is connected with a pressure regulator and a control valve 5 via an air hose 4. An example of a pressure regulator and a control valve will be explained in more detail below.

The pressure regulator is connected to an accumulator 7 via an air hose 6. From the air hose 6 a branch 10 stretches which connect the air hose 6 with a pump 8. In this example a bicycle pump is used, but in principle any pump may be used.

The air hose 6 is also provided with a pressure relief valve 9.

The pressure regulator and the control valve 5 will now be explained in more detail with reference to FIG. 2. FIG. 2 shows the bladder 3, the accumulator 7, the air hose 10, and the pressure relief valve 9. The pump 8 is not shown in FIG. 2. The pressure regulator and the control valve 5 consist of a pressure regulator 5a and a control valve 5b. In addition an adjustable restriction 5c is connected the control regulator. The restriction 5c is placed in line 4 in the example shown. However, it may also be placed in the line 5d, between the pressure regulator 5a and the control valve 5b. The purpose of the restriction is primarily to see to that the air is gradually let out of the bladder 3. The bladder will thereby also be filled slower. This will correspond to a normal breathing pattern. Meanwhile, it is also possible to place the restriction in an exhaust gas pipe 11 so that the air is restricted only when deflating the bladder.

The pressure regulator 5a sees to that the pressure supplied to the control valve 5b is limited to a pressure acceptable for the bladder 3. This pressure may for example be about 2 bar. It is also possible to adjust the pressure regulator 5a for adaptation to different bladders.

The control valve 5b is a two-way valve which in a first position let air from the pressure regulator 5a to the bladder 3. In a second position, as in FIG. 2, it lets air from the bladder to the exhaust gas pipe 11. At the end of the exhaust gas pipe a silencer 12 is provided.

The control valve is steered by a not shown processor via a wire-pair 13, which is connected with a solenoid 5e.

FIG. 3 shows an example of an actual embodiment of the present invention. The bladder 3 is assembled by two foil pieces which are welded or glued to each other along the edge. A first part 4a of the air hose 4 is permanently connected to the bladder 3. This is connected to a second part 4b of the air hose 4 via a quick coupling 14. On the air hose part 4b the restriction 5c is placed. Further one finds the control valve 5b. On the control valve the solenoid 5e is provided and connected to the wire-pair 13 for connection to the processor (not shown). The exhaust duct goes via the control valve 5b and the silencer 12 is provided on the house of the control valve 5b.

Further one finds the pressure regulator 5a, which is equipped with a wheel 5f for pressure adjustment of the regulator. Further along the air line 6 one finds the pressure relief valve 9, which is connected to the line 6 by a T-piece 6a. The actual pressure relief valve 9b is connected to the T-piece via a middle piece 9c.

Further the line 6 stretches against the accumulator 7. This may be a bottle stored in PET or polyvinyl. In principle a PET mineral water bottle may be used, but it will be practical to make a bottle particularly for the purpose, so that it may be shaped for the best use of space.

In line 6 there is also placed a T-piece 15, which connects line 6 with line 10. At the end of line 10 a quick coupling 16 is provided for the connection of a pump. This quick coupling may be of the same type as the one found on a bicycle- or car tyre, with an integrated non return valve.

All components, except the bladder 3 can be placed in the manikin's thigh, calf or hip where few components are already placed. The quick coupling 16 can also be placed elsewhere on the manikin, for example in an area where the rest of the connections to the manikin is gathered.

The object of the device will now be explained in more detail with reference to FIGS. 1-3. First a pressure is pumped into the accumulator 7 with the aid of the pump 8. The pressure may typically be 18-19 bar. When the pressure exceeds this, the pressure relief valve 9 will be triggered and release excess pressure. The pressure relief valve may prospectively also be provided with a whistle, which gives a sound signal when the excess pressure is released. When full pressure in the accumulator is obtained, the pump 8 may be detached.

The processor (not shown) can be set to initiate spontaneous breathing when certain physiological conditions are met or start the breathing randomly. The processor can also be manually overruled so that an instructor may start spontaneous breathing at will.

When spontaneous breathing is started the control valve 5b opens for air. Air thereby flows from the accumulator to the line 6, through the pressure regulator 5a and the control valve 5b to the bladder 3. Thus, the bladder 3 gets inflated and raises the breast plate (not shown), which causes the chest 2 of the manikin 1 to rise. The inflation may possibly also be accompanied by a breathing sound, which may be generated either by a sound distributor inside the manikin or because of the design of the above mentioned “respiratory passage”. During inflation of the bladder 3 the restriction 5c will limit the amount of air flowing to the bladder, so that there will be some time before the bladder is fully inflated. The time passed before the bladder is inflated may be regulated by adjusting the restriction 5c.

When the bladder 3 is to be deflated the control valve 5b is reversed to the position shown in FIG. 2. The bladder 3 is squeezed together by the breast plate (not shown) whish is located over the bladder 3. The air is thereby released from the bladder 3 back to the control valve 5b and out through the exhaust gas pipe 11. Thus, only one line is used for filling and return. This eases the line wiring. Instead of returning the air to the control valve, it is also possible to release the air close to the bladder 3 by providing a leakage hole which releases a smaller amount of air than that delivered at inflation.

FIG. 4 shows two examples of potential breathing patterns. The time is indicated along the horizontal axis and the ratio of fullness of the bladder (prospectively also pressure) is indicated along the vertical axis.

A curve 17 where air is let in during a period tᵢ is shown at the top. During the period tᵤ the air is released again. It is then a break during period tₚ, after which a new cycle begins.

An alternative breathing pattern is shown at the bottom at curve 18. Here air is let in during a period tᵢ. Thereafter the air is held in the bladder during the period tₕ. During the period tᵤ the air is released again. It is then a break during period tₚ, after which a new cycle begins. During the period tₕ the control valve 5b is open from air hose 5d to air hose 4 and the pressure is kept at the level of which the pressure regulator set.

It is of course possible to specify other types of breathing patterns. By regulating the time the control valve 5b is open in one or the other direction one may for example simulate hyper ventilation or faint breathing. The control valve 5b may possibly also be provided with a third position, where both air supply to the bladder 3 and return of air from the bladder 3 is closed, so that it is possible to keep the bladder filled with less air than the maximum allowed by the pressure regulator 5a, in order to simulate for example faint breathing. The not shown processor can be loaded with different programs for operation of the control valve 5b in the different breathing patterns.

1. A medical training manikin to simulate spontaneous breathing, comprising a torso containing at least one pneumatic actuator for obtaining raise of the manikin's chest or stomach, characterized in that the actuator is connected to an accumulator via a control valve, which is designed to let air from the accumulator into the actuator, said accumulator is designed to be temporarily connected to an external pneumatic source for filling the accumulator with a pneumatic pressure adequate for repeated actuations by the actuator.

2. A device according to claim 1, characterized in that the actuator is a bladder.

3. A device according to claim 1, characterized in that it comprises a pressure regulator placed in the communication path between the accumulator and the actuator.

4. A device according to claim 1, characterized in that it comprises a pressure relief valve, which is designed to release excess pressure during filling of the accumulator.

5. A device according to claim 1, characterized in that the control valve is connected to the actuator via only one line, which act as both a filling line for the actuator and as a return line.

6. A device according to claim 1, characterized in that it comprises a coupling for the connection of an external air source, for example a bicycle pump.

7. A device according to claim 1, characterized in that the accumulator is a plastic bottle, for example of PET or polyvinyl.

8. A device according to claim 1, characterized in that the control valve is a two-way valve designed to be controlled from a processor in the simulator.

9. A device according to claim 1, characterized in that it comprises a restriction designed to limit the amount of pneumatic fluid released from the actuator, so that the exhalation takes some time.

10. A device according to claim 9, characterized in that the restriction is placed between the accumulator and the actuator, so that also the supply of pneumatic fluid to the actuator is limited.

11. A device according to claim 2, characterized in that it comprises a pressure regulator placed in the communication path between the accumulator and the actuator.

12. A device according to claim 2, characterized in that it comprises a pressure relief valve, which is designed to release excess pressure during filling of the accumulator.

13. A device according to claim 3, characterized in that it comprises a pressure relief valve, which is designed to release excess pressure during filling of the accumulator.

14. A device according to claim 11, characterized in that it comprises a pressure relief valve, which is designed to release excess pressure during filling of the accumulator.

15. A device according to claim 2, characterized in that the control valve is connected to the actuator via only one line, which act as both a filling line for the actuator and as a return line.

16. A device according to claim 3, characterized in that the control valve is connected to the actuator via only one line, which act as both a filling line for the actuator and as a return line.

17. A device according to claim 4, characterized in that the control valve is connected to the actuator via only one line, which act as both a filling line for the actuator and as a return line.

18. A device according to claim 11, characterized in that the control valve is connected to the actuator via only one line, which act as both a filling line for the actuator and as a return line.

19. A device according to claim 12, characterized in that the control valve is connected to the actuator via only one line, which act as both a filling line for the actuator and as a return line.
